(19) United States
(12) Patent Application Publication
(10) Pub. No.: US 2014/0369396 A1
(43) Pub. Date: Dec. 18, 2014

(54) WIRED COMMUNICATION APPARATUS AND WIRED COMMUNICATION METHOD

(71) Applicant: FUNAI ELECTRIC CO., LTD., Osaka (JP)

(72) Inventor: Hideyuki TANAKA, Osaka (JP)

(73) Assignee: FUNAI ELECTRIC CO., LTD., Osaka (JP)

(21) Appl. No.: 14/294,354

(22) Filed: Jun. 3, 2014

(30) Foreign Application Priority Data
Jun. 18, 2013 (JP) 2013-127989

(51) Int. Cl. H04B 3/46

(52) U.S. Cl. CPC H04B 3/46
USPC 375/228

(57) ABSTRACT

Provided is a wired communication apparatus which communicates using a cable. The wired communication apparatus includes: a signal output unit and a bi-directional low-speed communication unit which transmit data to the cable; and a cable characteristic determining unit which measures the capacitance of the cable, and determines whether the cable is normal or abnormal according to the measured capacitance.

### CROSS REFERENCE TO RELATED APPLICATION

The present application is based on and claims priority of Japanese Patent Application No. 2013-127989 filed on Jun. 18, 2013. The entire disclosure of the above-identified application, including the specification, drawings and claims is incorporated herein by reference in its entirety.

### FIELD

The present invention relates to a wired communication apparatus and a wired communication method for communicating data using a cable.

### BACKGROUND

Conventionally, a video signal output device such as an AV device or a gaming machine outputs a video signal to a video signal receiving device such as a television receiver (TV) through wired communication using a cable conforming to the standard of HDMI (registered trademark, an abbreviation of High-Definition Multimedia Interface). The video signal is, for example, a video of content such as a movie and a broadcast program.

Here, the cable which connects the video signal output device and the video signal receiving device has a length, capacitance, etc. defined by the HDMI standard.

However, if a degraded cable or a cable which does not conform to the standard is used, a video signal which is output from the video signal output device degrades before reaching the video signal receiving device, which may result in a communication error.

In view of this, techniques have been disclosed each of which is intended to detect such a communication error due to degradation of a video signal, based on an error signal which is transmitted from the video signal receiving device (for example, see Patent Literature 1).

### CITATION LIST

### Patent Literature

### [PTL 1]

Japanese Unexamined Patent Application Publication No. 2008-193168

### [PTL 2]

PCT International Publication No. 2009-118851

### SUMMARY

### Technical Problem

However, the device disclosed in Patent Literature 1 determines a communication error using an error signal from a video signal receiving device, and thus needs to receive the error signal as a response from a video signal receiving device.

The device disclosed in Patent Literature 1 switches communication using a high-speed path to communication using a low-speed path when an error signal is detected, and thus has a problem that, when the low-speed path is a degraded one, the error signal is degraded and cannot be received properly by the video signal output device.

The present invention was made to solve the above-described problem, and has an object to provide a wired communication apparatus and a wired communication method for appropriately determining whether a cable is normal or abnormal.

### Solution to Problem

In order to achieve the above-described object, a wired communication apparatus according to an aspect of the present invention performs communication using a cable, and include: a communication unit configured to transmit data to the cable; and a cable characteristic determining unit configured to measure a capacitance of the cable and determine whether the cable is normal or abnormal based on the capacitance.

The wired communication apparatus is configured to measure the capacitance of the cable and determine whether the cable is normal or abnormal, and thus does not need to receive any response from the video signal receiving device.

In addition, since the wired communication apparatus is configured to measure the capacitance of the cable and determine whether the cable is normal or abnormal, it can determine whether the cable is normal or abnormal also in the case where a communication path for low-speed communication is degraded or does not conform to standards.

For example, the cable characteristic determining unit may be configured to determine that the cable is abnormal when the capacitance is larger than or equal to a first threshold value.

In general, a longer cable has a larger capacitance. In order to perform normal communication, the wired communication apparatus needs to output a video signal exerting a larger driving performance as the capacitance of the cable becomes larger. When the cable has a capacitance larger than the capacitance (for example, the first threshold value) corresponding to the maximum driving performance of the wired communication apparatus, the wired communication apparatus cannot perform normal communication.

When the capacitance is larger than the first threshold value, the wired communication apparatus is configured to determine that the cable is abnormal, in other words, the wired communication apparatus can determine that the cable which does not enable normal communication is abnormal.

In addition, when determining that the cable is abnormal, the cable characteristic determining unit may be configured to display an alert screen notifying that the cable is abnormal on a display device connected to the wired communication apparatus.

The wired communication apparatus is configured to display the alert screen when determining that the cable is abnormal, thereby prompts a user to use a cable which is not degraded and conforms to the standard.

In addition, when determining that the cable is abnormal, the cable characteristic determining unit may be configured to switch a current communication frequency to a communication frequency lower than the current communication frequency.

When determining that the cable is abnormal, the wired communication apparatus is configured to reduce the communication frequency to a communication frequency for lower speed communication. In this way, the wired communication apparatus can handle an error if it occurs.

In addition, when determining that the cable is abnormal, the cable characteristic determining unit may further be configured to: cause the communication unit to repeat transmitting data to a video signal receiving device which returns a communication error signal in case of a communication error while sequentially switching a current communication frequency to a communication frequency lower than the current communication frequency until the video signal receiving device stops returning a communication error signal; and set a communication frequency at a time when the video signal receiving device stops returning the communication error signal, as a communication frequency to be used by the communication unit.

The wired communication apparatus is configured to automatically identify a communication frequency at which no error signal is received, and thus is capable of communicating when determining that the cable is abnormal.

In addition, the wired communication apparatus may further include a storage unit which stores a connection history table including records indicating communication frequencies used by the communication unit, device unique information indicating the video signal receiving device, and capacitances of the cable measured by the cable characteristic determining unit, when determining that the cable is abnormal, the cable characteristic determining unit may be configured to obtain the device unique information indicating the video signal receiving device, searches the connection history table for a record indicating the device information and a capacitance of the cable measured by the cable characteristic determining unit, and when the record is searched out, obtain a communication frequency used by the communication unit from the record.

The wired communication apparatus is configured to use the connection history table including records of communications each performed by the wired communication apparatus at the time when a cable was determined to be abnormal in the past. This makes it easier to set a communication frequency when a cable is determined to be abnormal.

In addition, determining that the cable is abnormal, the cable characteristic determining unit may be configured to derive the communication frequency to be used by the communication unit, using a driving performance of the communication unit and the capacitance of the cable measured by the cable characteristic determining unit.

The wired communication apparatus is configured to calculate a communication frequency available by the communication unit, based on the driving performance of the communication unit and the capacitance of the cable. Thus, the wired communication apparatus is solely capable of calculating the available communication frequency without using a signal from the video signal receiving device.

In addition, the cable may include a first line unit for communication frequencies lower than or equal to a first communication frequency and a second line unit for communication frequencies lower than or equal to a second communication frequency lower than the first communication frequency, and the cable characteristic determining unit may be configured to measure a capacitance of the second line unit.

The wired communication apparatus is configured to measure the capacitance of the low-speed communication path when the cable includes the high-speed communication path (the first line unit) for communication using a comparatively high frequency and the high-speed communication path (the second line unit) for communication using a comparatively low frequency. In other words, the wired communication apparatus is configured to measure the capacitance in the low-speed communication path which is considered to enable communication comparatively less affected by the measurement of the capacitance. In this way, it is possible to reduce influence of the measurement of the capacitance on the high-speed communication.

In addition, the communication unit may be configured to output a measurement signal having a square wave, at a time of measuring the capacitance of the cable, and the cable characteristic determining unit may be configured to measure the capacitance of the cable by measuring a rise time of the measurement signal at the time of measuring the capacitance of the cable.

When the measurement signal having the square wave is output, the measurement signal shows a longer rise time with an increase in the capacitance of the cable. In other words, the capacitance of the cable and the rise time of the measurement signal have a correlation relationship. Utilizing this correlation relationship, the wired communication apparatus is configured to measure the rise time of the measurement signal having the square wave, as a physical quantity corresponding to the capacitance of the cable.

In addition, the cable characteristic determining unit may include an A/D converter, and measure the rise time of the measurement signal by causing the A/D converter to sample the measurement signal using a frequency higher than a communication frequency of the measurement signal at the time of measuring the capacitance of the cable.

The wired communication apparatus having a comparatively simple structure includes the A/D converter for measuring the rise time of the measurement signal having the square wave, and thus is capable of measuring the rise time using the A/D converter.

In addition, the cable characteristic determining unit may be configured to determine that the cable is abnormal when the rise time of the measurement signal is longer than or equal to the second threshold value.

The wired communication apparatus is configured to determine whether the cable is normal or abnormal, by assuming, to be the second threshold value, the rise time of the measurement signal corresponding to the cable capacitance with which normal communication cannot be performed and comparing the rise time with the second threshold value. In this way, the wired communication apparatus is simply configured to be capable of determining whether the cable is normal or abnormal.

It is noted here that the present invention cannot only be realized as the wired communication apparatus including the above-described unique processing units, but also as a wired communication method having the steps corresponding to the processes performed by the unique processing units of the wired communication apparatus. Furthermore, the present invention can also be realized as a program for causing a computer to function as the unique processing units of the wired communication apparatus or a program causing a computer to execute the unique steps of the wired communication method. Furthermore, the programs can naturally be distributed after being recorded on non-transitory computer-readable recording media such as Compact Disc Read Only Memory (CD-ROM) or through communication networks such as the Internet.

### ADVANTAGEOUS EFFECTS

The present invention provides a wired communication apparatus capable of properly determining whether a cable is normal or abnormal.

### BRIEF DESCRIPTION OF DRAWINGS

These and other objects, advantages and features of the invention will become apparent from the following description there of taken in conjunction with the accompanying drawings that illustrate a specific embodiment of the present invention.

[FIG. 1]

FIG. 1 is a block diagram showing structures of a wired communication apparatus, a cable, and a video signal receiving device.

[FIG. 2]

FIG. 2 is a diagram showing a connection history table storing connection history including records of communications performed when a cable is determined to be abnormal.

[FIG. 3]

FIG. 3 is a flowchart showing processing operations performed by a wired communication apparatus 1.

[FIG. 4]

FIG. 4 is a flowchart showing a procedure for measuring a capacitance.

[FIG. 5]

FIG. 5 is a graph showing a relationship between a waveform of a clock signal and a rise time.

[FIG. 6]

FIG. 6 is a diagram showing an example of an error display screen.

[FIG. 7A]

FIG. 7A is a diagram showing a circuit configuration of a series resistance bridge circuit.

[FIG. 7B]

FIG. 7B is a diagram showing a circuit configuration of a parallel resistance bridge circuit.

### DESCRIPTION OF EMBODIMENTS

Hereinafter, embodiments of the present invention are described in detail with reference to the drawings. Each of the drawings does not necessarily illustrate precise dimensions, ratios etc.

In addition, in each of the embodiment and variations thereof described below shows a preferred specific example of the present invention. The numerical values, shapes, materials, structural elements, the arrangement and connection of the structural elements, steps, the processing order of the steps etc. shown in the following exemplary embodiment and variations are mere examples, and therefore do not limit the scope of the present invention. The present invention is defined by the Claims. Therefore, among the elements in the following exemplary embodiment and variations, structural elements not recited in any one of the independent claims are not necessarily required to achieve the object of the present invention but are described as optional elements which constitute the preferred embodiment and so on.

### Embodiment 1

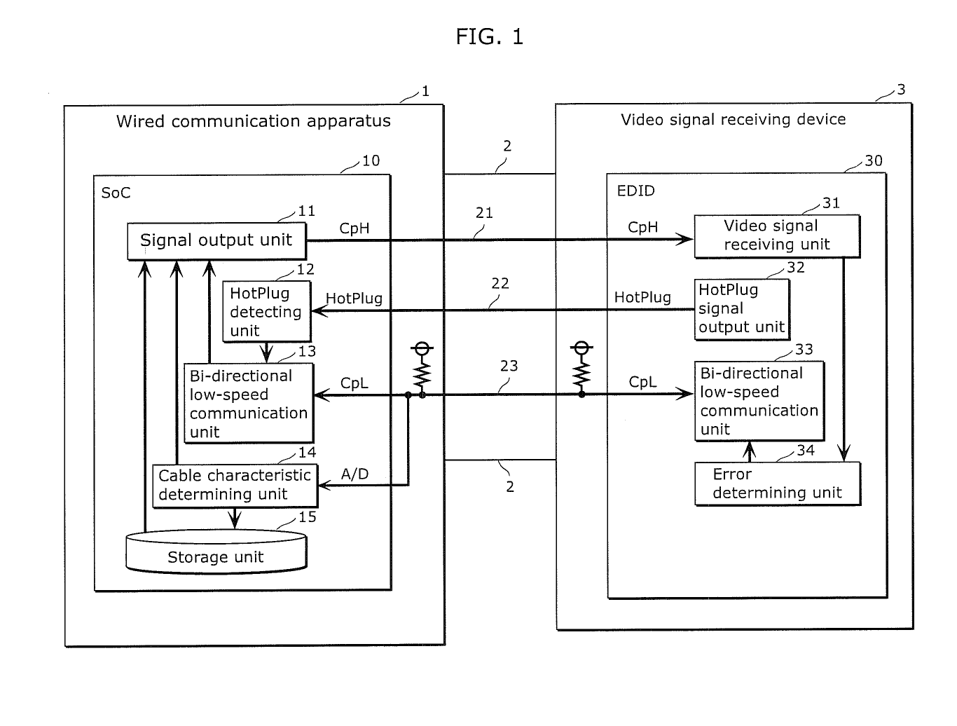

A wired communication apparatus according to Embodiment 1 is described based on FIGS. 1 to 5. FIG. 1 is a block diagram showing structures of the wired communication apparatus 1, a cable 2, and a video signal receiving device 3.

The wired communication apparatus 1 according to this embodiment measures a capacitance of the cable 2, and switches communication frequencies according to the capacitance.

### [1-1. Structure of Wired Communication Apparatus 1]

The wired communication apparatus 1 in this embodiment is a Blu-ray (registered trademark) Disc (BD) recorder which has a communication function conforming to the HDMI (registered trademark) standard, and outputs a video signal to the video signal receiving device 3 using the communication function. Here, the wired communication apparatus 1 may be a Digital Versatile Disc (DVD) recorder or a digital device such as a gaming machine. The video signal is, for example, a video of content such as a movie and a broadcast program.

As shown in FIG. 1, the wired communication apparatus 1 is configured to include a System-on-a-Chip (SoC) 10 which realizes a communication function conforming to the HDMI (registered trademark) standard, and a terminal (not shown) for connecting the line parts of the cable 2.

The SoC 10 includes a signal output unit 11, a HotPlug detecting unit 12, a bi-directional low-speed communication unit 13, a cable characteristic determining unit 14, and a storage unit 15. Here, the terminal to which the second line part 23 of the cable 2 is connected to both the bi-directional low-speed communication unit 13 and the cable characteristic determining unit 14. Here, the signal output unit 11 and the bi-directional low-speed communication unit 13 constitute a communication unit which transmits data to the cable 2.

For example, the signal output unit 11 outputs a video signal to the video signal receiving device 3 using high-speed communication through the cable 2. Frequencies for use in high-speed communication are several hundred MHz, for example, frequencies lower than or equal to 340 MHz. Here, frequencies for use in high-speed communication may be several frequencies, and different values may be set according to the magnitude etc. of a video signal to be output.

The HotPlug detecting unit 12 detects connection of the wired communication apparatus 1 and the video signal receiving device 3 using the cable 2 in a power-on state.

The bi-directional low-speed communication unit 13 performs bi-directional low-speed communication with the video signal receiving device 3. The communication frequencies for use in low-speed communication are lower than frequencies for use in high-speed communication.

For example, the bi-directional low-speed communication unit 13 performs authentication on the video signal receiving device 3 when the video signal receiving device 3 is connected. The bi-directional low-speed communication unit 13 determines the connection of the video signal receiving device 3 when the HotPlug detecting unit 12 detects connection of the wired communication apparatus 1 and the video signal receiving device 3.

Furthermore, the bi-directional low-speed communication unit 13 in this embodiment keeps outputting, for a predetermined period, a measurement signal for determining whether the cable 2 is normal or abnormal when the cable 2 is connected. The measurement signal in this embodiment is a clock signal having a rectangular wave.

The cable characteristic determining unit 14 includes a measuring unit which measures a capacitance of the cable 2, a determining unit which determines whether the cable 2 is normal or abnormal according to the capacitance of the cable 2 measured by the measuring unit, and a communication frequency setting unit which switches communication frequencies in the signal output unit 11.

The measuring unit in this embodiment measures the capacitance of the cable 2 using the A/D converter connected to the second line part 23 (the low-speed communication path for low-speed communication) of the cable 2. The A/D converter is connected to the second line part 23 for low-speed communication because it is considered that the second line part 23 for low-speed communication enables communication comparatively less affected by the connection of the A/D converter, compared to communication by the first line part 21 for high-speed communication. Here, the measuring unit operates in synchronization with the bi-directional low-speed communication unit 13.

The determining unit determines whether the cable 2 is normal or abnormal using the capacitance measured by the measuring unit. The method for determining whether the cable is normal or abnormal is described in detail later.

The communication frequency setting unit resets a current communication frequency to a lower communication frequency when the determining unit determines that the cable 2 is abnormal.

The storage unit 15 is configured to include a Random Access Memory (RAM), a Read Only Memory (ROM), or the like. The storage unit 15 in this embodiment stores a connection history table storing connection history including records of communications each performed when a cable was determined to be abnormal. The connection history includes, per record, the device ID (an example of device information) of the video signal receiving device 3, the capacitance, and the communication frequency.

### [1-2. Structure of Cable 2]

The cable 2 in this embodiment is a cable conforming to the HDMI (registered trademark) standard. The cable 2 in this embodiment includes the first line part 21, a HotPlug line part 22, and the second line part 23.

The first line part 21 is a line for high-speed communication, and enables communication at a frequency lower than or equal to a first communication frequency. The first line part 21 connects the signal output unit 11 of the wired communication apparatus 1 and the video signal receiving unit 31 of the video signal receiving device 3. Here, the first line part 21 may be composed of a plurality of lines.

The HotPlug line part 22 is a line which transmits a HotPlug signal. The HotPlug line part 22 connects the HotPlug detecting unit 12 of the wired communication apparatus 1 and the HotPlug signal output unit 32 of the video signal receiving device 3.

The second line part 23 is a line for low-speed communication, and enables communication at a frequency lower than or equal to a second communication frequency lower than the first communication frequency. The second line part 23 connects the bi-directional low-speed communication unit 13 of the wired communication apparatus 1 and the bi-directional low-speed communication unit 33 of the video signal receiving device 3. In addition, in this embodiment, the cable characteristic determining unit 14 of the wired communication apparatus 1 is connected to the second line part 23. Here, the second line part 23 may be composed of a plurality of lines.

### [1-3. Structure of Video Signal Receiving Device 3]

The video signal receiving device 3 in this embodiment is a television receiver which has a communication function conforming to the HDMI (registered trademark) standard, and receives a video signal from the wired communication apparatus using the communication function. The video signal receiving device 3 decodes a video signal, and then displays video on a display screen and outputs audio from the speaker. Here, the video signal receiving device 3 may be a liquid crystal display connectable to a Personal Computer (PC), an AV amplifier for use in an audio device, or the like, instead of being the television receiver.

The video signal receiving device 3 includes an extended display identification data (EDID) circuit 30 for inter-device authentication and a terminal (not shown) for connecting the cable 2.

The EDID circuit 30 includes a video signal receiving unit 31, a HotPlug signal output 32, a bi-directional low-speed communication unit 33, and an error determining unit 34.

The video signal receiving unit 31 receives a video signal from the wired communication apparatus 1 by high-speed communication through the cable 2. Frequencies for use in high-speed communication are lower than or equal to the above-described first communication frequency.

When detecting connection of the cable 2, the HotPlug signal output 32 outputs a HotPlug signal to the wired communication apparatus 1.

The bi-directional low-speed communication unit 33 performs bi-directional communication with the wired communication apparatus 1. Frequencies for use in bi-directional communication are lower than or equal to the above-described second communication frequency.

The error determining unit 34 determines a communication error using the video signal received by the video signal receiving unit 31.

### [1-4. Operations Performed by Wired Communication Apparatus 1]

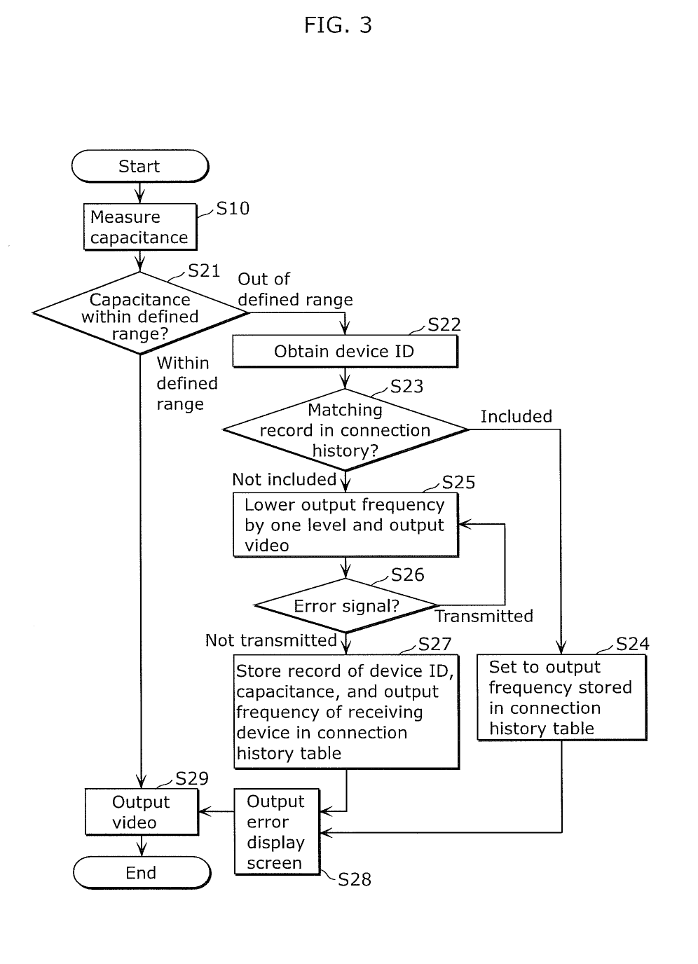

Operations performed by the wired communication apparatus 1 are described with reference to FIGS. 3 to 5. FIG. 3 is a flowchart indicating processing operations performed by the wired communication apparatus 1.

The wired communication apparatus 1 in this embodiment performs processing operations shown in FIG. 3, for example, when the HotPlug detecting unit 12 detects the HotPlug signal and the wired communication apparatus 1 is turned on.

### [1-4-1. Measurement of Capacitance]

When connection of the cable 2 is detected, the cable characteristic determining unit 14 of the wired communication apparatus 1 measures the capacitance thereof (Step S10). In this embodiment, the cable characteristic determining unit 14 measures a rise time of a clock signal as a value corresponding to the capacitance of the cable 2. Here, a time constant T of the second line part 23 can be expressed according to T =CR where C denotes a capacitance of the second line part and R denotes a resistance value R of the second line part 23 (the resistance value is a value of a pull-up resistance of the wired communication apparatus 1 and the signal receiving device 3 shown in FIG. 1). The time constant T corresponds to the rise time of the clock signal. The range of pull-up resistance values are defined by the HDMI standard. In other words, the rise time of the clock signal corresponds to the capacitance of the second line part 23.

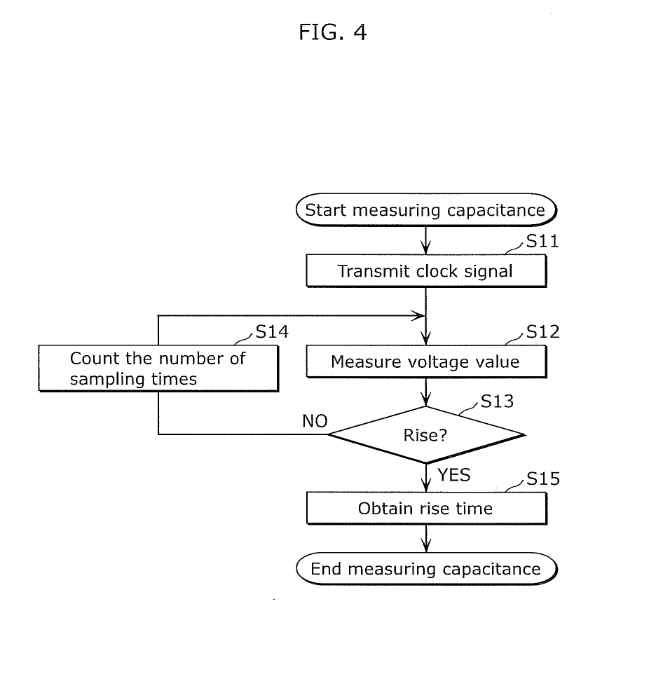

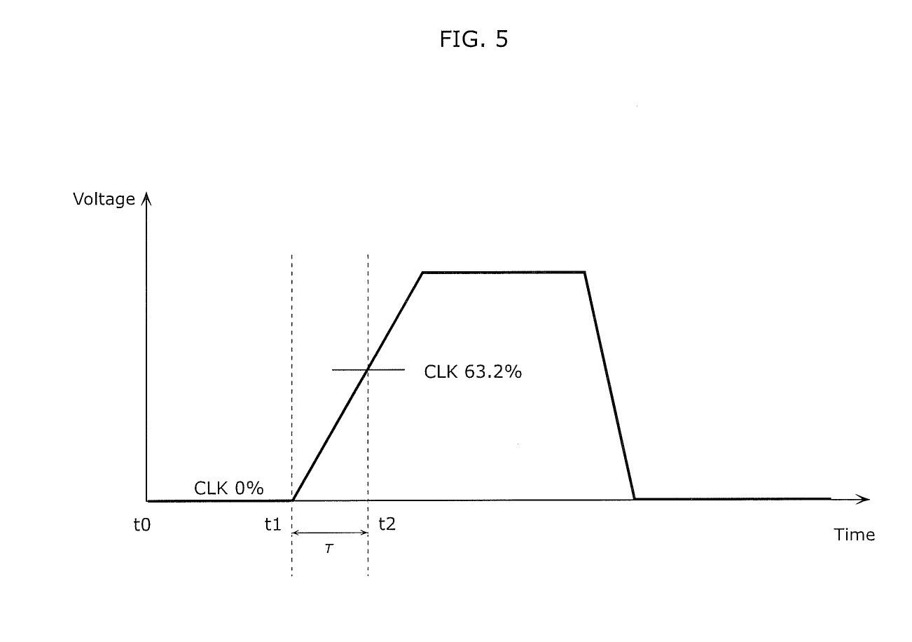

FIG. 4 is a flowchart showing a procedure for measuring the capacitance. FIG. 5 is a graph showing the relationship between a waveform and a rise time of the clock signal.

When the measurement of the capacitance is started, the bi-directional low-speed communication unit 13 outputs a clock signal for measuring a rise time (Step S11). The frequency of the clock signal for measurement is, for example, 100 MHz. Here, the frequency of the clock signal for measurement is not limited thereto, and may be, for example, a frequency for use in low-speed communication performed by the bi-directional low-speed communication unit 13.

When the clock signal for measurement is output from the bi-directional low-speed communication unit 13 (S11), the cable characteristic determining unit 14 measures a voltage value of the second line part 23 using the A/D converter (S12). Here, the sampling frequency f of the A/D converter is assumed to be a frequency at which the rise time of the clock signal can be measured. The sampling frequency f may be, for example, five times or more of the frequency of the clock signal for measurement.

The cable characteristic determining unit 14 determines whether the clock signal rises or not using a voltage value of the second line part 23 (S13). As shown in FIG. 5, when the voltage value of the second line part 23 of the cable 2 becomes larger than or equal to a predetermined voltage value, the cable characteristic determining unit 14 determines the rise of the clock signal. The predetermined voltage value is, for example, a value corresponding to 63.2% of a voltage value at the high level with respect to a voltage value at the low level. Here, the predetermined value is not limited to 63.2% of the voltage value of the H-level, and may be a voltage value with which the rise of the clock signal can be determined.

When the output value from the A/D converter is lower than or equal to the predetermined value in Step S13, the cable characteristic determining unit 14 determines the clock signal does not rise (“NO” in Step S13), and increments the number of sampling times by 1 (S14). Here, the number of sampling times is set to 0 when the output value of the A/D converter is 0 (a period from time t0 to time t1 in FIG. 5), and the number of sampling times is incremented by 1 when the output value of the A/D converter is not 0. With this configuration, it is possible to calculate the number of sampling times from the time t1 at which the rise starts (hereinafter also referred to as the rise starting time t1).

When the output value from the A/D converter is lower than or equal to the predetermined voltage value in Step S13, the cable characteristic determining unit 14 determines that the clock signal rises (“YES” in S13), and obtains the rise time (S15). The rise time T is time elapsed from the rise starting time t1 of the clock signal to the time t2 at which the voltage of the clock signal becomes higher than or equal to the predetermined voltage value, and can be calculated according to T=n/f based on the number of sampling times n and the sampling frequency f described above.

### [1-4-2. Settings of Communication Frequency]

After measuring the capacitance (S10), the cable characteristic determining unit 14 determines whether the measured capacitance is within a defined range or not as shown in FIG. 3 (S21).

In this embodiment, the cable characteristic determining unit 14 determines whether the rise time T of the clock signal which is the value corresponding to the capacitance of the cable 2 is smaller than or equal to a second threshold value Tt.

Here, for example, the HDMI (registered trademark) standard allows the capacitance of the cable 2 to be up to 800 pF (an example of a first threshold value Ct). The second threshold value Tt is set by deriving a value corresponding to the first threshold value Ct from the relationship represented by a time constant T=a capacitance C×a resistance value R of the second line part 23.

The cable characteristic determining unit 14 determines that the capacitance is within the defined range when the rise time T is smaller than or equal to the second threshold value Tt, and determines that the capacitance is out of the defined range when the rise time T is larger than or equal to the second threshold value Tt.

When determining that the capacitance is within the defined range in Step S21 (“within defined range” in S21), a transition to Step S29 is made.

When determining that the capacitance is out of the defined range in Step 521 (“out of defined range” in S21), the cable characteristic determining unit 14 obtains the device ID of the video signal receiving device 3 (S22).

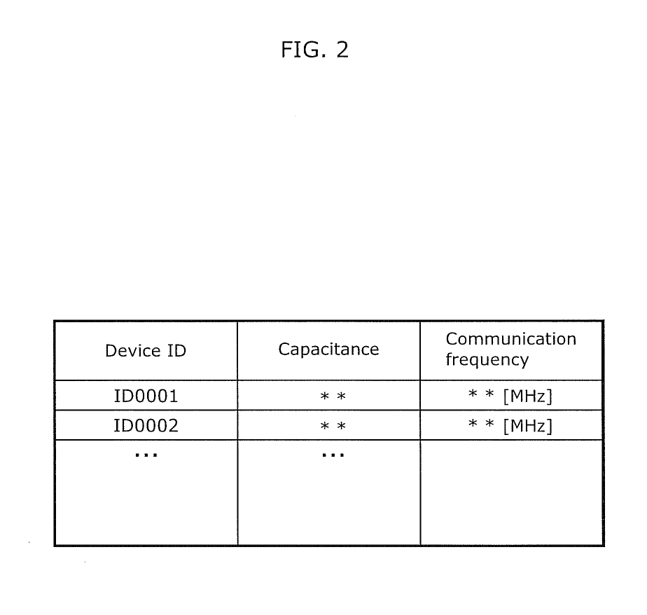

The cable characteristic determining unit 14 searches for a record having the device ID and capacitance (the rise time T of the clock signal) which match thereto from the connection history table shown in FIG. 2 so as to determine whether there is a matching record in the connection history (S23 in FIG. 3). When such a matching record is searched out, the cable characteristic determining unit 14 determines that the matching record is included.

When determining that the matching record is included in the connection history in Step S23 (“included” in S23), the cable characteristic determining unit 14 obtains the communication frequency included in the record searched out in the Step S23, and sets the obtained communication frequency as the communication frequency to be used for the video signal (S24).

When determining that such a matching record is not included in the connection history in Step S23 (“not included” in S23), the cable characteristic determining unit 14 calculates the communication frequency of the video signal.

More specifically, the cable characteristic determining unit 14 resets a current communication frequency (for example, a first communication frequency) of the video signal to a frequency lower by one level than the current communication frequency, and outputs a video signal from the signal output unit 11 (S25).

When an error signal is transmitted from the video signal receiving device 3 (“included” in S26), a transition to Step S25 is made.

When no error signal is transmitted from the video signal receiving device 3 (“None” in S26), a record of the device ID of the video signal receiving device 3, the capacitance (rise time T) thereof, and the communication frequency of a current video signal are added to the connection history table shown in FIG. 2 (S27).

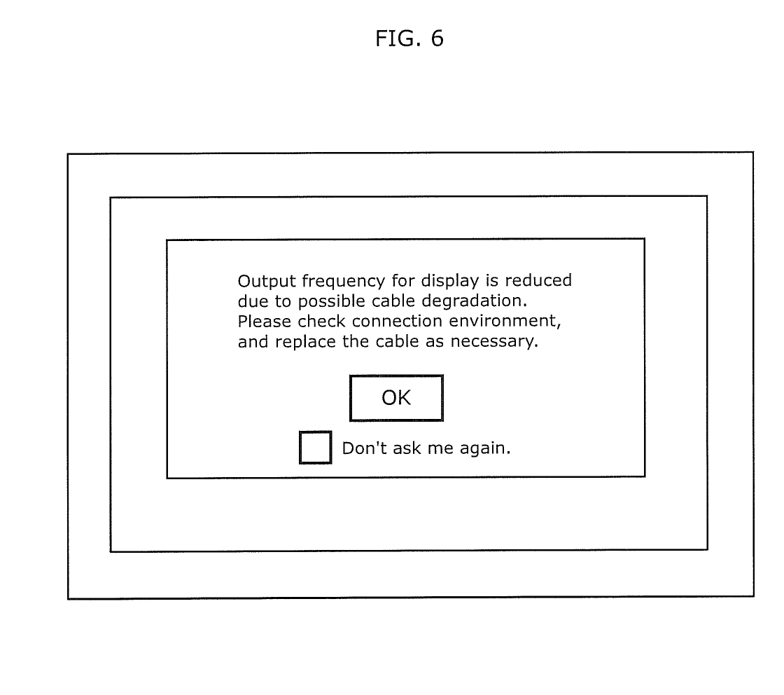

After the execution of Step S24 and Step S27, the signal output unit 11 outputs an error display screen indicating that the cable was determined to be abnormal to the video signal receiving device 3 (S28). FIG. 6 is a diagram showing an example of an error display screen. The error display screen shown in FIG. 6 includes a message indicating that the cable is degraded.

Here, the degree of degradation of the cable may be determined based on the capacitance, and display indicating the degree of degradation may be added to the error display screen.

When it is determined that the capacitance is within the defined range in Step S21 (“within defined range” in S21) and after the execution of Step S28, the signal output unit 11 outputs a video signal at the set communication frequency to the video signal receiving device 3 (S29).

The communication frequency in the case where the capacitance is determined within the defined range in Step S21 (“within defined range” in S21) is a communication frequency in the case where the cable is determined to be normal. The communication frequency in the case where the cable is determined to be normal is, for example, a first communication frequency. Here, the communication frequency of the video signal here may be another frequency.

### [1-5. Advantageous Effect etc.]

In this embodiment, it is possible to determine whether the cable is normal or abnormal by only modifying the structure of the wired communication apparatus 1 side without requiring a signal from the video signal receiving device 3.

In addition, when a cable longer than defined in the standard is used, for example, a conventional structure for determining whether the cable is normal or abnormal by detecting an error signal, may not be able to recognize a signal output in a low-speed communication path by the video signal receiving device 3 and to properly transmit the error signal. In this embodiment, whether the cable is normal or abnormal is determined based on the capacitance of the cable without using the signal from the video signal receiving device 3, it is possible to determine whether the cable is normal or abnormal more precisely.

### Variations

Although the wired communication apparatus according to Embodiment 1 has been described above, the present invention is not limited thereto.

(1) In the Embodiment, a rise time T of the clock signal is calculated as the capacitance of the cable 2, which is a non-limiting example.

For example, the cable characteristic determining unit 14 may derive the capacitance from the rise time T of the clock signal (S15 of FIG. 4). In this case, in Step S21 of FIG. 5, the wired communication apparatus 1 may determine whether the capacitance is smaller than or equal to a first threshold value, or may determine the capacitance is within a defined range when the capacitance is smaller than or equal to the first threshold value.

In addition, for example, the cable characteristic determining unit 14 may use the number of sampling times as a value corresponding to the rise time, that is, as a value corresponding to the capacitance because the rise time T of the clock signal and the number of sampling times are in a directly proportional relationship (S15 in FIG. 4). In this case, in Step S21 of FIG. 5, the wired communication apparatus 1 may be configured to determine whether the number of sampling times is smaller than or equal to a predetermined threshold value, and to determine the capacitance is within the defined range when the number of sampling times is smaller than or equal to the predetermined threshold value.

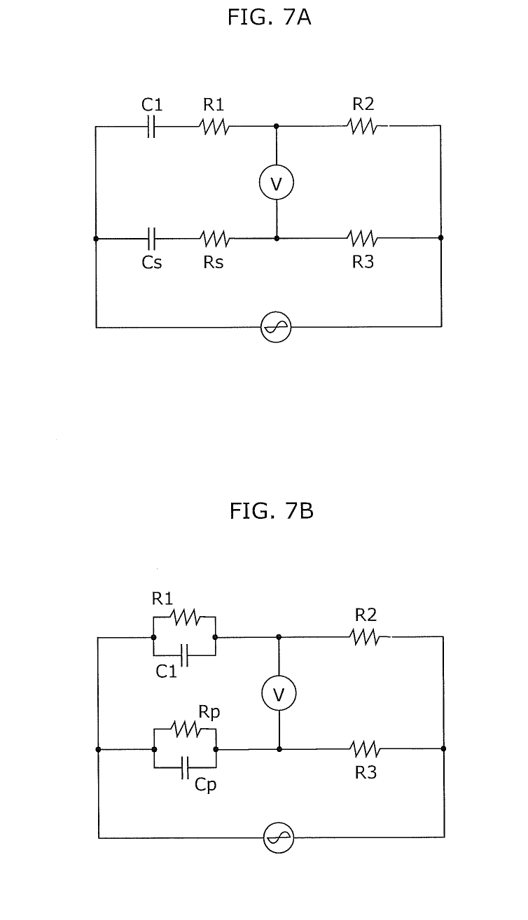

(2) In the above embodiment, the A/D converter is used to measure the capacitance of the cable 2 and measure the rise time of the clock signal, but this is a non-limiting example. For example, a series resistance bridge circuit shown in FIG. 7A or a parallel resistance bridge circuit shown in FIG. 7B may be used to measure a capacitance and a rise time instead.

(3) The above embodiment describes an example where the cable 2 is a cable conforming to the HDMI (registered trademark) standard, but this is a non-limiting example. Any cable such as a cable conforming to the digital visual interface (DVI) standard may be used as long as the cable is for use with at least two kinds of communication frequencies including a first communication frequency for high-speed communication and a second communication frequency for comparatively low-speed communication.

(4) In the above embodiment, the communication frequency in the case where the cable 2 is determined to be abnormal is calculated based on whether or not a communication error is detected by sequentially reducing output frequencies as shown in Steps S25 and S26 in FIG. 3. However, this is a non-limiting example. For example, it is also good to store in advance a driving performance of an output signal from the wired communication apparatus 1, and to derive a proper communication frequency using the driving performance and the capacitance.

(5) In this embodiment, the wired communication apparatus 1 includes the bi-directional low-speed communication unit 13 for low-speed communication. However, bi-directional communication is not always necessary.

(6) Each of the aforementioned apparatuses may be specifically configured as a computer system including a microprocessor, a ROM, a RAM, a hard disk drive, a display unit, a keyboard, a mouse, and so on. The respective apparatuses achieve their functions through the microprocessor's operations according to the computer program. Here, the computer program is configured by combining plural instruction codes indicating instructions for the computer. Here, the computer program is configured to exert predetermined functions by combining plural instruction codes indicating instructions for the computer.

Furthermore, a part or all of the structural elements of the respective apparatuses may be configured with a single system-LSI (Large-Scale Integration). The system-LSI is a super-multi-function LSI manufactured by integrating structural units on a single chip, and is specifically a computer system configured to include a microprocessor, a ROM, a RAM, and so on. A computer program is stored in the RAM. The system-LSI achieves its function through the microprocessor's operations according to the computer program.

A part or all of the constituent elements constituting the respective apparatuses may be configured as an IC card which can be attached to and detached from the respective apparatuses or as a stand-alone module. The IC card or the module is a computer system configured from a microprocessor, a ROM, a RAM, and so on. The IC card or the module may also be included in the aforementioned super-multi-function LSI. The IC card or the module achieves its functions through the microprocessor's operations according to the computer program. The IC card or the module may also be implemented to be tamper-resistant.

Furthermore, the present invention may be realized as the above-described methods. The present invention may be realized as computer programs for causing computers to execute these methods, or as digital signals presenting the computer programs.

Furthermore, the present invention may also be implemented as computer programs or digital signals recorded on computer-readable recording media such as a flexible disc, a hard disk, a CD-ROM, an MO, a DVD, a DVD-ROM, a DVD-RAM, a Blu-ray (registered trademark) Disk (BD), and a semiconductor memory. In addition, the present invention may also be implemented as the digital signals recorded on these non-transitory recording media.

In addition, the present invention may also be implemented as the aforementioned computer programs or digital signals transmitted via a telecommunication line, a wireless or wired communication line, a network represented by the Internet, a data broadcast, and so on.

In addition, the present invention may also be implemented as a computer system including a microprocessor and a memory, in which the memory stores the aforementioned computer program and the microprocessor operates according to the computer program.

Furthermore, it is also possible to execute another independent computer system by transmitting the programs or the digital signals recorded on the non-transitory recording media, or by transmitting the programs or digital signals via the aforementioned network and the like.

In addition, the embodiment and variations thereof may be arbitrarily combined.

Although only an exemplary embodiment of the present invention has been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The present invention is applicable to Blu-ray (registered trademark) Disc (BD) recorders, digital devices such as gaming machines, digital devices which are connected to the video signal receiving device using a cable.

1. A wired communication apparatus which performs communication using a cable, the wired communication apparatus comprising:
a communication unit configured to transmit data to the cable; and
a cable characteristic determining unit configured to measure a capacitance of the cable and determine whether the cable is normal or abnormal based on the capacitance.

2. The wired communication apparatus according to claim 1,
wherein the cable characteristic determining unit is configured to determine that the cable is abnormal when the capacitance is larger than or equal to a first threshold value.

3. The wired communication apparatus according to claim 1,
wherein when determining that the cable is abnormal, the cable characteristic determining unit is configured to display an alert screen notifying that the cable is abnormal on a display device connected to the wired communication apparatus.

4. The wired communication apparatus according to claim 1,
wherein when determining that the cable is abnormal, the cable characteristic determining unit is configured to switch a current communication frequency to a communication frequency lower than the current communication frequency.

5. The wired communication apparatus according to claim 1,
wherein when determining that the cable is abnormal, the cable characteristic determining unit is further configured to:
cause the communication unit to repeat transmitting data to a video signal receiving device which returns a communication error signal in case of a communication error while sequentially switching a current communication frequency to a communication frequency lower than the current communication frequency until the video signal receiving device stops returning a communication error signal; and
set a communication frequency at a time when the video signal receiving device stops returning the communication error signal, as a communication frequency to be used by the communication unit.

6. The wired communication apparatus according to claim 5, further comprising
a storage unit which stores a connection history table including records indicating communication frequencies used by the communication unit, device unique information indicating the video signal receiving device, and capacitances of the cable measured by the cable characteristic determining unit,
when determining that the cable is abnormal, the cable characteristic determining unit is configured to obtain the device unique information indicating the video signal receiving device, searches the connection history table for a record indicating the device information and a capacitance of the cable measured by the cable characteristic determining unit, and when the record is searched out, obtain a communication frequency used by the communication unit from the record.

7. The wired communication apparatus according to claim 1,
when determining that the cable is abnormal, the cable characteristic determining unit is configured to derive the communication frequency to be used by the communication unit, using a driving performance of the communication unit and the capacitance of the cable measured by the cable characteristic determining unit.

8. The wired communication apparatus according to claim 1,
wherein the cable includes a first line unit for communication frequencies lower than or equal to a first communication frequency and a second line unit for communication frequencies lower than or equal to a second communication frequency lower than the first communication frequency, and
the cable characteristic determining unit is configured to measure a capacitance of the second line unit.

9. The wired communication apparatus according to claim 1,
wherein the communication unit is configured to output a measurement signal having a square wave, at a time of measuring the capacitance of the cable, and
the cable characteristic determining unit is configured to measure the capacitance of the cable by measuring a rise time of the measurement signal at the time of measuring the capacitance of the cable.

10. The wired communication apparatus according to claim 9,
wherein the cable characteristic determining unit includes an A/D converter, and measures the rise time of the measurement signal by causing the A/D converter to sample the measurement signal using a frequency higher than a communication frequency of the measurement signal at the time of measuring the capacitance of the cable.

11. The wired communication apparatus according to claim 9,
wherein the cable characteristic determining unit is configured to determine that the cable is abnormal when the rise time of the measurement signal is longer than or equal to the second threshold value.

12. A wired communication method which is performed by a wired communication apparatus which performs communication using a cable, the wired communication method comprising:
measuring a capacitance of the cable; and
determining whether the cable is normal or abnormal according to the capacitance of the cable.
